(19) United States
(12) Patent Application Publication
(10) Pub. No.: US 2013/0054139 A1
(43) Pub. Date: Feb. 28, 2013

(54) Location of Available Passenger Seats in a Dynamic Transporting Pool

(71) Applicants: William Bodin, Austin, TX (US); Indiver N. Dwivedi, Pune (IN); David Jaramillo, Lake Worth, FL (US)

(72) Inventors: William Bodin, Austin, TX (US); Indiver N. Dwivedi, Pune (IN); David Jaramillo, Lake Worth, FL (US)

(73) Assignee: International Business Machines Corporation, Armonk, NY (US)

(21) Appl. No.: 13/221,499

(22) Filed: Aug. 30, 2011

(51) Int. Cl. G01C 21/34; G06Q 10/00

(52) U.S. Cl. 701/468; 701/484; 705/7.27

(57) ABSTRACT

An embodiment of the invention provides a system including an interface for receiving a request from a rider, wherein the request includes a start location of the rider and an end location of the rider. A vehicle identification module connected to the interface identifies at least one vehicle located within a threshold distance from the start location. A communications module connected to the vehicle identification module sends the request to a driver of the vehicle. A validation module connected to the interface verifies that the rider and the driver and/or the vehicle were each located at the start location at the same time, and verifies that the rider and the driver and/or the vehicle were each located at the end location at the same time.

### BACKGROUND

The present invention is in the field of systems, methods, and computer program products for location of available passenger seats in a dynamic transporting pool.

With the consistent increase of car ownership, fuel scarcity, fuel price, air pollution and traffic congestion, commuters have started opting for shared transportation systems. Some organizations operate server based car pooling systems, where a driver stores his route information, including start and destination locations, and time of departure on a server, and where potential passengers can then scan for suitable drivers. Other organizations run private or non-profit car-pooling systems on the Internet. Many of these operate through a similar text based user interface where drivers specify their start and end locations through which a passenger must either search manually or for whom the car-pool organization searches.

### SUMMARY OF THE INVENTION

An embodiment of the invention provides a system and method for locating available passenger seats in a dynamic transporting pool. More specifically, the system includes an interface for receiving a request from a rider, wherein the request includes a start location of the rider and an end location of the rider. A vehicle identification module connected to the interface identifies at least one vehicle located within a threshold distance from the start location. A communications module connected to the vehicle identification module sends the request to a driver of the vehicle. A validation module connected to the interface verifies that the rider and the driver and/or the vehicle were each located at the start location at the same time, and verifies that the rider and the driver and/or the vehicle were each located at the end location at the same time. In at least one embodiment of the invention, the communications module also provides the rider and/or the driver of the vehicle with reward credits when the driver drops off the rider at the end location.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method for locating available passenger seats in a dynamic transporting pool according to an embodiment of the invention;

FIG. 2 illustrates a system for a dynamic transporting pool according to an embodiment of the invention;

FIG. 3 illustrates a system for using a dynamic transporting pool according to another embodiment of the invention;

FIG. 4 illustrates a method for using a dynamic transporting pool according to an embodiment of the invention;

FIG. 5 illustrates a system and method for on demand according to an embodiment of the invention;

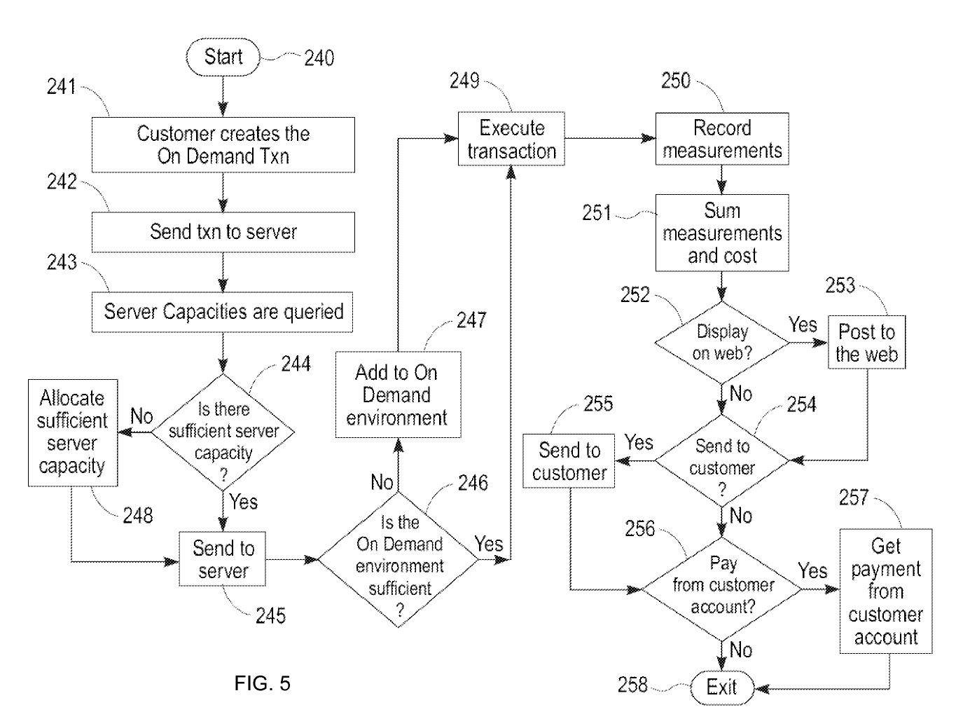

FIG. 6 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides a dynamic method and system for determining availability of seats in a vehicle. The system includes a client side mobile application to accept user requests and query a server. A server application is also included to find all available registered vehicles and the number of available seats on a given route.

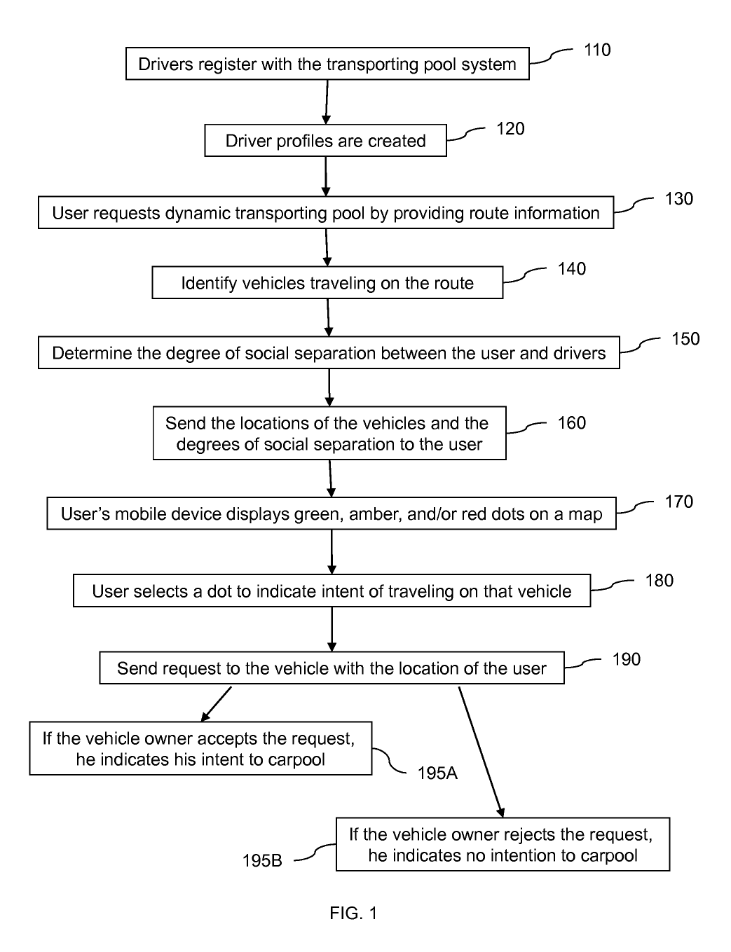

FIG. 1 is a flow diagram illustrating a method for locating available passenger seats in a dynamic transporting pool according to an embodiment of the invention. A driver registers with the transporting pool system by providing his vehicle information (e.g., make, model, year, vehicle identification number, and/or vehicle registration number), common route(s) of travel, and/or typical number of available seats 110. The driver's profile is created based on the information provided 120. In at least one embodiment, the driver's profile also includes a list of traffic offenses and criminal violations obtained from one or more external databases. In another embodiment, the driver's profile includes rider feedback (e.g., ratings (e.g., based on promptness) and/or comments).

A user requests dynamic transporting pool information from his mobile device by providing his route information 130. As used herein, the term “mobile device” includes cellular telephones, tablet computers, and other web-enabled devices. For example, the user (also referred to herein as the “rider”) provides a pickup location and a destination location. In at least one embodiment, the system also includes rider profiles, which include, for example, a list of criminal violations and/or driver feedback (e.g., ratings (e.g., based on promptness), comments). The transporting pool system receives the request and identifies the number of vehicles currently traveling on that route by looking up GPS/LBS information 140.

In at least one embodiment of the invention, the transporting pool system determines the degree of social separation between the requesting user and available vehicle owners (also referred to herein as “drivers”) 150. The transporting pool system sends the location of all of the vehicles traveling on the route along with the degree of social separation of each vehicle owner to the user 160. As used herein, the term “location” includes longitude and latitude coordinates, a street address, a street intersection, and/or other identifying location, such as a bus stop, train station, or commuter park-and-ride lot. In at least one embodiment, the user's mobile device displays green, amber, and/or red dots on a map 170, wherein the color of dot indicates the degree of separation between the user and the driver (e.g., Green=friend, Amber=friend of a friend, Red=unknown). The user selects a dot to indicate his intent of traveling on that vehicle 180. The mobile device sends this message to a server of the transporting pool system; and, the server sends this request to the vehicle owner with the location (e.g., geographical coordinates or street address) of the requesting user 190.

If the vehicle owner accepts the request, he indicates his intent to carpool 195A. The server sends a confirmation back to the requesting user and decrements the number of available seats for that vehicle in the server database. The server posts a message to the Message Queue (MQ) and stores this Ride Share Event. In at least one embodiment, this event in the MQ can be consumed by external/enterprise applications to calculate emission savings in terms of green units and/or to calculate award points to recognize people offering vehicle sharing.

If the vehicle owner rejects the request, he indicates no intention to carpool 195B. The server confirms back to the requesting user so that a new ride request can be sent by the requesting user. In at least one embodiment, the server marks the vehicle as not available.

At least one embodiment of the invention allows for advance trip registration where the vehicle owner logs-in to the system to register her trip in advance. More specifically, the vehicle owner provides trip information, such as, for example, trip date, trip start point, trip end point, trip start time, and estimated trip end time. The server stores the trip information into an advance trips database.

In at least one embodiment, to request a trip in advance, the requesting user logs-in to the system to register her trip in advance. The requesting user posts an advance trip request by indicating her intent to use a shared ride in the future. The requesting user provides trip details such as, for example, trip date, trip start point, trip end point, trip start time, and estimated trip end time. The server stores the trip detail into the advance trips database.

At least one embodiment of the invention provides for advance trip notification. This is invoked by a process that is scheduled to run at a specific frequency (e.g., every day at 6:00 AM). The system checks if there are any pending trip requests in the advance trip request database. For each pending request, the system finds out if there are trips registered in the database that match the request criteria of start point, end point, start date, start time, and/or end time. For each matching entry, a notification is sent to the requester, indicating the availability of a ride. If a requesting user accepts the notification, thereby indicating her confirmation that she will take the ride, the confirmation is recorded by decrementing the number of seats available on that ride. The system sets a timed event (e.g., 60 minutes prior to trip start time), which informs the vehicle owner (e.g., via short message service (SMS)) of the number of pick-ups en-route.

In at least one embodiment of the invention, the system contains a user profile database, social network service, location service (e.g., GPS/LBS), communication service (e.g., SMS), client mobile application, and server application. The user profile database stores user profile information, such as, for example, name, address, user identification number, mobile telephone number, and/or vehicle information (e.g., registration number, number of seats in the vehicle, and/or common traveling routes). The social network service includes a social networking system that can provide a service to query the social degree of separation between any two user profiles. For example, the social network service queries an external social networking system X to determine the social degree of separation between user R and driver D. The location service provides a geographical positioning/location service that can provide location details of a mobile phone as, for example, X/Y coordinates or street address. The communication service sends messages (e.g., text messages) to registered users. The client mobile application accepts user requests, initiates queries to the server, receives responses from the server, and displays maps to the user. The server side application computes the available vehicles on a given route and the number of available seats per vehicle.

In at least one embodiment of the invention, the manager of the shared transportation system posts a message to the MQ series on completion of every successful transaction. The MQ events are updated in the profile data. A vehicle/driver profile provider component and a rider profile provider component takes data from a database, and provides the data to a credit analyzer to calculate credits. In one embodiment, this calculation is a function of the type of vehicle (e.g., sports utility vehicle, sedan, sports car, truck, hybrid engine, electric engine), distance traveled, gross vehicle weight, fuel economy of vehicle, and/or time of day. The credits can be used by external applications, award systems, and/or emission savings calculators. The credits can be converted to cash, virtual currency, carbon credits, and/or for exchange in other accepted systems.

In at least one embodiment, the ride profile provider includes a unique identification number of the ride, start time, end time, start address, end address, start coordinates (latitude, longitude), and/or end coordinates (latitude, longitude). In at least one embodiment, the coordinates are generated by the system based on the street addresses. In another embodiment, the ride profile provider includes the distance traveled, vehicle registration number, identification number of the driver, and/or identification number of the rider. In at least one embodiment of the invention, the vehicle profile provider includes the vehicle type, gross vehicle weight, fuel economy (e.g., miles per gallon), vehicle registration number, and/or driver identification number.

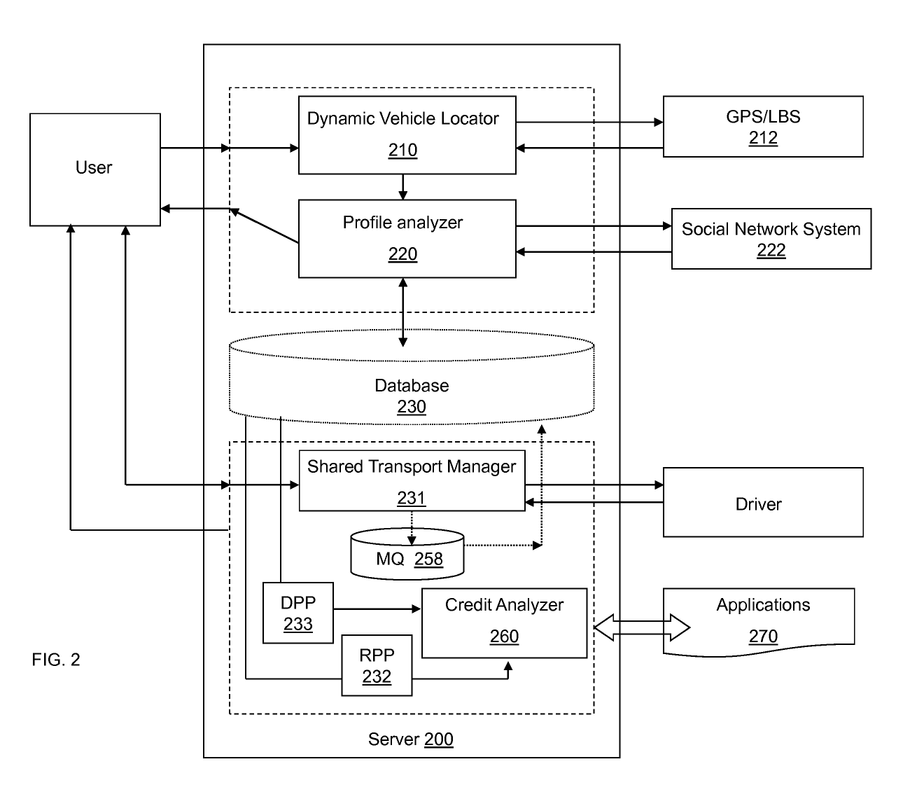

FIG. 2 illustrates a system for a dynamic transporting pool according to an embodiment of the invention. A user inputs route information on to a mobile device (e.g., Location From <Home>, Location To <Office>). The route information is sent to a dynamic vehicle locator 210 (also referred to herein as a “vehicle identification module”) on a server 200, which creates a list of vehicles traveling on a given route in real-time. The dynamic vehicle locator 210 is connected to a GPS/LBS system 212. As used herein, the term “connected” includes operationally connected, logically connected, in communication with, physically connected, engaged, coupled, contacts, linked, affixed, and attached.

The dynamic vehicle locator 210 is also connected to a profile analyzer 220 (also referred to herein as a “validation module”). The profile analyzer 220 is connected to a social network system 222, which is an external or self-contained system having the capability of finding the degree of separation between any two users. The profile analyzer 220 queries the social network system 222 to get the degree of separation between the user and the drivers of the vehicles identified by the dynamic vehicle locator 210. The profile analyzer 220 connects to the user's mobile device and returns the locations of the identified vehicles/drivers. As described above, the user's mobile device displays a route map with green, amber, and red dots. In at least one embodiment, the profile analyzer 220 only sends the locations of drivers who are socially connected to the user (e.g., within 3 degrees of social separation).

In at least one embodiment of the invention, the profile analyzer 220 is connected to a database 230 having driver profile data and rider profile data, wherein the profile analyzer 220 updates the database 230 with the results of the query of the social network system 222. The database 230 is connected to a shared transport manager 231, which accepts requests from people in need of transport. More specifically, the user selects a driver/vehicle from the route map; and, the shared transport manager 231 sends a message (e.g., SMS) to the driver/vehicle, which includes the location of the requesting user. The driver responds to the shared transport manager 231 by accepting or rejecting the ride request, which is then communicated to the user.

In at least one embodiment of the invention, the shared transport manager 231 is connected to a message queue 258 (also referred to herein as a “validation module”), which stores ride share events. The message queue 258 posts data to the database 230, which stores rider and driver profile data. A rider profile provider (RPP) 232 and a driver profile provider (DPP) 233 take this data from the database 230 and provide it to a credit analyzer 260. In at least one embodiment, the credit analyzer 260 is connected to external/enterprise applications 270 to calculate emission savings in terms of green units and/or to calculate award points to recognize people offering vehicle sharing.

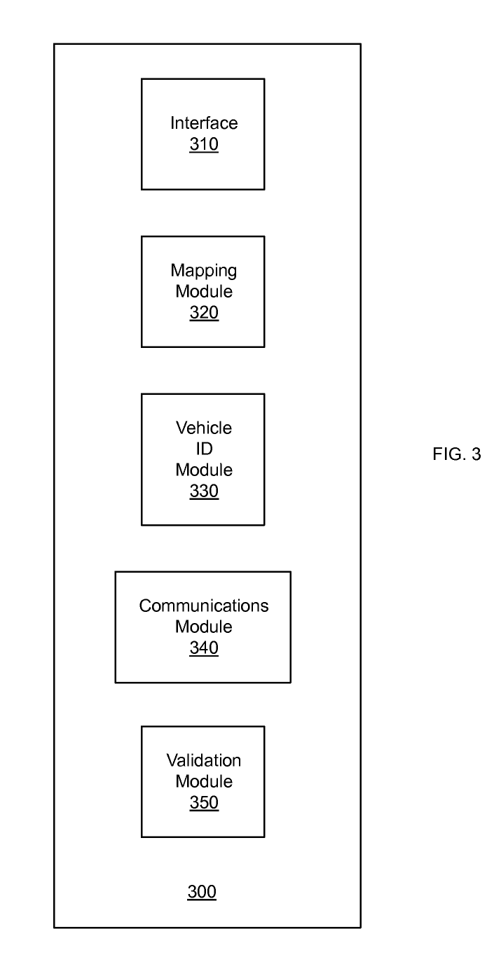

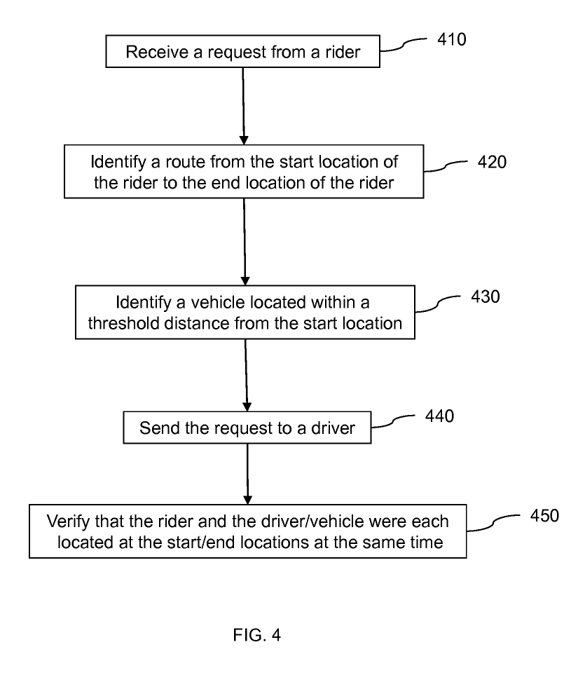

FIG. 3 illustrates a system 300 for using a dynamic transporting pool according to another embodiment of the invention. FIG. 4 illustrates a method for using a dynamic transporting pool according to an embodiment of the invention, for example, using the system 300. The system 300 includes an interface 310 for receiving a request from a rider, wherein the request includes a start location of the rider (also referred to herein as a “pickup location”) and an end location of the rider (also referred to herein as a “destination location”) 410. For example, the rider uses his mobile telephone to submit “Germantown/Milestone” as the start location and “intersection of K and 17th streets NW, Washington, D.C.” as the end location.

A mapping module 320 is connected to the interface 320, wherein the mapping module 320 identifies a route from the start location of the rider to the end location of the rider 420. In at least one embodiment of the invention, the mapping module 320 calculates the route based on the estimated shortest distance between the start and end locations. In another embodiment, the route is calculated based on the estimated shortest traveling time between the start and end locations. This calculation may take into account delays in travel (e.g., traffic, road construction, accidents). In yet another embodiment, the mapping module 320 calculates the route based on the route that is most commonly traveled between the start and end locations.

A vehicle identification module 330 is connected to the mapping module 320, wherein the vehicle identification module 330 identifies at least one vehicle located within a threshold distance (e.g., 10 miles, 15 km) from the start location 430. The threshold distance is a predetermined distance (e.g., 10 miles from the start location) defined by the user, driver(s), and/or an administrator of the system 300. For instance, as discussed above, the user's mobile device displays an interactive map showing registered drivers in the user's area in real time using GPS tracking.

In at least one embodiment, the vehicle identification module 330 only identifies vehicles/drivers that are scheduled to travel along a route that includes a location that is a threshold distance from the end location. The schedules of the drivers are obtained from an external source (e.g., the driver's electronic scheduling calendar) and/or via manual entry into a database of the system 300 by the drivers (i.e., the drivers register trips in advance).

A communications module 340 is connected to the vehicle identification module 330, wherein the communications module 340 sends the request to a driver of the vehicle(s) 440. For example, the communications module 340 sends a message to the driver's mobile device and/or to a communications device built-in to the vehicle, where the message includes the identification of the user, the start location, the end location, a map showing the start location, a map showing the end location, a map showing the route, a trip start time (e.g., after 5:30 PM, 6:00 PM-6:20 PM), and an estimated trip end time (e.g., before 8:00 PM, 7:45 PM-8:15 PM). In another example, the message only includes the identification of the user, a trip start time, and an estimated trip end time.

A validation module 350 is connected to the interface 310, wherein the validation module 350 verifies that the rider and the driver and/or the vehicle were each located at the start location at the same time, and verifies that the rider and the driver and/or the vehicle were each located at the end location at the same time 450. Thus, the validation module 350 verifies that the ride share event actually took place (i.e., that the driver picked up and dropped off the rider), which is useful in providing reward credits, as described below.

In at least one embodiment of the invention, the validation module 350 verifies that the rider and the driver and/or the vehicle were each located at the start location at the same time by confirming that the GPS location of the rider matches the GPS location of the driver and/or vehicle at the start time. For instance, if the GPS location of the rider matches the GPS location of the driver or vehicle at the start time (e.g., 7:00 AM), then the validation module 350 confirms that the pickup occurred. As used herein, the term “matching” two or more locations that are within a threshold distance from one another (e.g., within 10 meters). In another embodiment, the validation module 350 verifies that the rider and the driver are co-located via mutual confirmation by the rider and driver (e.g., via text message or web interface).

Moreover, the validation module 350 verifies that the rider and the driver and/or vehicle were each located at the end location at the same time by confirming that the GPS location of the rider matches the GPS location of the driver or vehicle at the end time. For instance, if the GPS location of the rider matches the GPS location of the driver or vehicle at the end time (e.g., 8:20 AM), then the validation module 350 confirms that the drop off occurred.

In at least one embodiment of the invention, the validation module 350 determines the degree of social separation between the rider and the driver by querying an external social networking system or other database (e.g., a rideshare registry). For example, the validation module 350 queries social networking system S and identifies that a rider and a driver have a social separation of 3 degrees (i.e., the rider is friends with John, John is friends with Amy, and Amy is friends with the driver). In another example, the validation module 350 queries professional networking system P and identifies that a rider and a driver live in the same neighborhood, work for the same employer, and/or work in the same office building.

In at least one embodiment, the validation module 350 compares the identified degree of social separation with a threshold degree of social separation. The threshold degree of social separation is defined or updated by the rider, driver, and/or an administrator of the system 300. In one embodiment of the invention, the request is only sent to the driver if the identified degree of social separation is at or below the threshold degree of social separation (e.g., the request is only sent if the rider is within 4 degrees of social separation). In another embodiment, the driver or vehicle is only displayed to the rider if the identified degree of social separation is at or below the threshold degree of social separation. In yet another embodiment, if the rider and driver have selected different threshold degrees of separation, the rider and driver are matched only if the identified degree of social separation is at or below the lowest threshold degree of separation of the rider or driver. For example, if the rider's select threshold is 2 degrees of social separation, the driver's threshold is 5 degrees of social separation, then the rider and driver are matched only if the identified degree of social separation is 1 or 2.

In at least one embodiment of the invention, the driver and/or rider is provided with reward credits when the driver drops off the rider at the end location. In one embodiment, the reward credits are only given after the validation module 350 verifies that the rider and driver/vehicle were each located at the start location at the same time, and that the rider and driver/vehicle were each located at the end location at the same time. The amount of the reward credits provided to the driver and/or rider is based on the distance traveled between the start location of the rider and the end location of the rider, the time period between when the rider was picked up and when the rider was dropped off, the type of vehicle (of the driver and/or rider), gross weight of the vehicle, net weight of the vehicle, fuel economy of the vehicle, time of day, day of week (e.g., Monday, Friday, weekday, weekend, holiday), number of rider pickups, fuel consumption savings from rider pickups, and/or emissions savings from rider pickups.

The process software (e.g., IBM WebSphere® Process Server software, IBM Business Process Manager) is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements f use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

Step 240 begins the On Demand process. A transaction is created than contains the unique customer identification, the requested service type and any service parameters that further specify the type of service 241. The transaction is then sent to the main server 242. In an On Demand environment the main server can initially be the only server, and then as capacity is consumed other servers are added to the On Demand environment.

The server central processing unit (CPU) capacities in the On Demand environment are queried 243. The CPU requirement of the transaction is estimated, then the server's available CPU capacity in the On Demand environment is compared to the transaction CPU requirement to see if there is sufficient CPU available capacity in any server to process the transaction 244. If there is not sufficient server CPU available capacity, then additional server CPU capacity is allocated to process the transaction 248. If there was already sufficient Available CPU capacity then the transaction is sent to a selected server 245.

Before executing the transaction, a check is made of the remaining On Demand environment to determine if the environment has sufficient available capacity for processing the transaction. This environment capacity consists of such things as but not limited to network bandwidth, processor memory, storage etc. 246. If there is not sufficient available capacity, then capacity will be added to the On Demand environment 247. Next the required software to process the transaction is accessed, loaded into memory, and then the transaction is executed 249.

The usage measurements are recorded 250. The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer 251.

If the customer has requested that the On Demand costs be posted to a web site 252 then they are posted 253. If the customer has requested that the On Demand costs be sent via email to a customer address 254 then they are sent 255. If the customer has requested that the On Demand costs be paid directly from a customer account 256 then payment is received directly from the customer account 257. The last step is exit the On Demand process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, portable computer diskette, hard disk, random access memory (RAM), read-only memory (ROM), erasable programmable read-only memory (EPROM or Flash memory), optical fiber, portable compact disc read-only memory (CD-ROM), optical storage device, magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of at least one programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

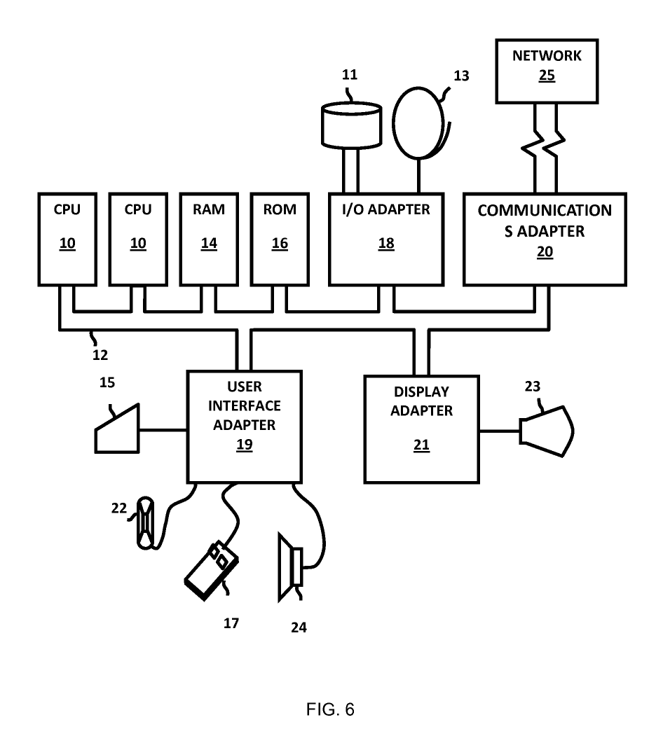

Referring now to FIG. 6, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving a request from a rider, the request including a start location of the rider and an end location of the rider;
identifying a route from the start location of the rider and the end location of the rider;
identifying at least one vehicle located within a threshold distance from the start location;
sending the request to a driver of the vehicle;
verifying that the rider and at least one of the driver and the vehicle were each located at the start location at the same time; and
verifying that the rider and at least one of the driver and the vehicle were each located at the end location at the same time.

2. The method according to claim 1, wherein said verifying that the rider and at least one of the driver and the vehicle were each located at the start location at the same time comprises confirming that a GPS location of the rider matches at least one of a GPS location of the driver and a GPS location of the vehicle at a start time, and
wherein said verifying that the rider and at least one of the driver and the vehicle were each located at the end location at the same time comprises confirming that a GPS location of the rider matches at least one of a GPS location of the driver and a GPS location of the vehicle match at an end time.

3. The method according to claim 1, further comprising:
determining a degree of social separation between the rider and the driver; and
comparing the degree of social separation with a threshold degree of social separation.

4. The method according to claim 3, wherein the request is sent to the driver of the vehicle only if the degree of social separation is one of equal to and less than the threshold degree of social separation.

5. The method according to claim 3, wherein the threshold degree of social separation is defined by at least one of the rider and the driver.

6. The method according to claim 3, wherein said determining of the degree of social separation comprises accessing at least one of a social networking website and a rideshare registry.

7. The method according to claim 1, further comprising providing at least one of the rider and the driver of the vehicle with reward credits when the driver drops off the rider at the end location.

8. The method according to claim 7, wherein an amount of the reward credits provided is based on at least one of:
distance traveled between the start location of the rider and the end location of the rider;
the time period between when the rider was picked up and when the rider was dropped off;
a type of the vehicle;
gross weight of the vehicle;
net weight of the vehicle;
fuel economy of the vehicle;
time of day;
day of week;
number of rider pickups;
fuel consumption savings from rider pickups; and
emissions savings from rider pickups.

9. A method comprising:
receiving a request from a rider, the request including a pickup location of the rider and a destination location of the rider;
identifying at least one vehicle located within a threshold distance from the pickup location;
sending the request to a driver of the vehicle;
providing at least one of the rider and the driver of the vehicle with reward credits when the driver drops off the rider at the destination location.

10. The method according to claim 9, wherein an amount of the reward credits provided is based on at least one of:
distance traveled between the pickup location of the rider and the destination location of the rider;
the time period between when the rider was picked up and when the rider was dropped off;
a type of the vehicle;
gross weight of the vehicle;
net weight of the vehicle;
fuel economy of the vehicle;
time of day;
day of week;
number of rider pickups;
fuel consumption savings from rider pickups; and
emissions savings from rider pickups.

11. The method according to claim 9, further comprising:
verifying that the rider and at least one of the driver and the vehicle were each located at the pickup location at the same time; and
verifying that the rider and at least one of the driver and the vehicle were each located at the destination location at the same time.

12. The method according to claim 11, wherein said verifying that the rider and at least one of the driver and the vehicle were each located at the pickup location at the same time comprises confirming that a GPS location of the rider matches at least one of a GPS location of the driver and a GPS location of the vehicle at a pickup time, and
wherein said verifying that the rider and at least one of the driver and the vehicle were each located at the destination location at the same time comprises confirming that a GPS location of the rider matches at least one of a GPS location of the driver and a GPS location of the vehicle at an destination time.

13. The method according to claim 9, further comprising:
determining a degree of social separation between the rider and the driver; and
comparing the degree of social separation with a threshold degree of social separation.

14. The method according to claim 13, wherein the request is sent to the driver of the vehicle only if the degree of social separation is one of equal to and less than the threshold degree of social separation.

15. The method according to claim 13, wherein the threshold degree of social separation is defined by at least one of the rider and the driver.

16. The method according to claim 13, wherein said determining of the degree of social separation comprises accessing at least one of a social networking website and a rideshare registry.

17. A system comprising:
an interface for receiving a request from a rider, the request including a start location of the rider and an end location of the rider;
a vehicle identification module connected to said interface, said vehicle identification module identifies at least one vehicle located within a threshold distance from the start location;
a communications module connected to said vehicle identification module, said communications module sends the request to a driver of the vehicle; and
a validation module connected to said interface, said validation module verifies that:
the rider and at least one of the driver and the vehicle were each located at the start location at the same time, and
the rider and at least one of the driver and the vehicle were each located at the end location at the same time.

18. The system according to claim 17, wherein said validation module confirms that:
a GPS location of the rider matches at least one of a GPS location of the driver and a GPS location of the vehicle at a start time, and
a GPS location of the rider matches at least one of a GPS location of the driver and a GPS location of the vehicle at an end time.

19. The system according to claim 17, wherein said validation module:
determines a degree of social separation between the rider and the driver; and
compares the degree of social separation with a threshold degree of social separation.

20. The system according to claim 19, wherein said communications module sends the request to the driver of the vehicle only if the degree of social separation is one of equal to and less than the threshold degree of social separation.

21. The system according to claim 19, wherein the threshold degree of social separation is defined by at least one of the rider and the driver.

22. The system according to claim 19, wherein said validation module accesses at least one of a social networking website and a rideshare registry.

23. The system according to claim 17, wherein said communications module provides at least one of the rider and the driver of the vehicle with reward credits when the driver drops off the rider at the end location.

24. The system according to claim 23, wherein an amount of the reward credits is based on at least one of:
distance traveled between the start location of the rider and the end location of the rider;
the time period between when the rider was picked up and when the rider was dropped off;
a type of the vehicle;
gross weight of the vehicle;
net weight of the vehicle;
fuel economy of the vehicle;
time of day;
day of week;
number of rider pickups; and
emissions savings from rider pickups.

25. A computer program product for a dynamic transporting pool, said computer program product comprising:
a computer readable storage medium;
first program instructions to receive a request from a rider, the request including a start location of the rider and an end location of the rider;
second program instructions to identify at least one vehicle located within a threshold distance from the start location;
third program instructions to send the request to a driver of the vehicle;
fourth program instructions to verify that the rider and at least one of the driver and the vehicle were each located at the start location at the same time; and
fifth program instructions to verify that the rider and at least one of the driver and the vehicle were each located at the end location at the same time,
said first program instructions, said second program instructions, said third program instructions, said fourth program instructions, and said fifth program instructions are stored on said computer readable storage medium.
